(19) United States
(12) Patent Application Publication
(10) Pub. No.: US 2012/0244734 A1
(43) Pub. Date: Sep. 27, 2012

(54) CARD EDGE CONNECTOR WITH FLOATABLE GROUNDING PADS

(75) Inventors: XIAO-ZHI FU, Kunshan (CN); ZE-LIN YAO, Kunshan (CN); ZHUANG-XING LI, Kunshan (CN)

(73) Assignee: HON HAI PRECISION INDUSTRY CO., LTD., New Taipei (TW)

(21) Appl. No.: 13/429,454

(22) Filed: Mar. 26, 2012

(30) Foreign Application Priority Data
Mar. 24, 2011 (CN) 201120081147.X

(51) Int. Cl. H01R 13/62; H01R 24/50

(52) U.S. Cl. 439/327; 439/637

(57) ABSTRACT

A card edge connector for connecting a card to a printed circuit board includes an insulative housing, a plurality of contacts and a pair of grounding pads. The insulative housing has a lengthwise base portion having a card-receiving slot and a pair of locating arms having an extending portion which extends forwardly from the base portion. The contacts are retained in the insulative housing and extend into the card-receiving slot to electrically contact with the inserted card. The grounding pads each include a main body which has a frame and a solder pad. The locating arms each further include a spring fork-shaped locking portion extending from the extending portion for preventing the grounding pad releasing from the corresponding locating arm when the frame of the grounding pad is securely seated in the extending portion from the locking portion.

### BACKGROUND OF THE INVENTION

1. Field of the Invention

The present invention relates to a card edge connector, and more particularly to a card edge connector incorporated with a pair of cantilevered beams on which a grounding pad is moveably attached thereto.

2. Description of Related Art

U.S. Pat. No. 8,052,449 B2 issued to Zhu on Nov. 8, 2011 discloses a card edge connector for mounting onto a printed circuit board. The card edge connector includes an elongated insulative housing which defines a central slot extending along a transverse direction with a plurality of contacts disposed therein, a pair of side arms disposed at opposite ends thereof and extending along a mating direction perpendicular to the transverse direction, a pair of grounding pads each floatably assembled onto a holding section which is formed adjacent to the corresponding side arm, and a pair of metal plates each respectively attached to the corresponding side arm and forming a blocking portion projecting toward the grounding pad for avoiding the grounding pad releasing from the holding section.

However, the metal plates which have blocking portions for resisting the grounding pads have complex structures and if the grounding pad is to be removed therefrom, the metal plate has to be removed firstly. Hence, an improved card edge connector is highly desired to overcome the aforementioned problem.

### SUMMARY OF THE INVENTION

Accordingly, an object of the present invention is to provide a card edge connector having a grounding pad which can be easily disassembled from the card edge connector if required, and can compensates any co-planarity among the contacts.

In order to achieve the object set forth, a card edge connector for connecting a card to a printed circuit board includes an insulative housing, a plurality of contacts and a pair of grounding pads. The insulative housing has a lengthwise base portion having a card-receiving slot and a pair of locating arms having an extending portion which extends forwardly from the base portion. The contacts are retained in the insulative housing and extend into the card-receiving slot to electrically contact with the inserted card. The grounding pads each include a main body which has a frame and a solder pad. The locating arms each further include a spring fork-shaped locking portion extending from the extending portion for preventing the grounding pad releasing from the corresponding locating arm when the frame of the grounding pad is securely seated in the extending portion from the locking portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled perspective view of a card edge connector according to the present invention;

FIG. 2 is a view similar to FIG. 1, while taken from a different angle;

FIG. 3 is a partly exploded perspective view of the card edge connector shown in FIG. 1, and

FIG. 4 is a partly amplified perspective view of the card edge connector shown in FIG. 3.

### DETAILED DESCRIPTION OF THE INVENTION

Reference will now be made to the drawing figures to describe the preferred embodiment of the present invention in detail.

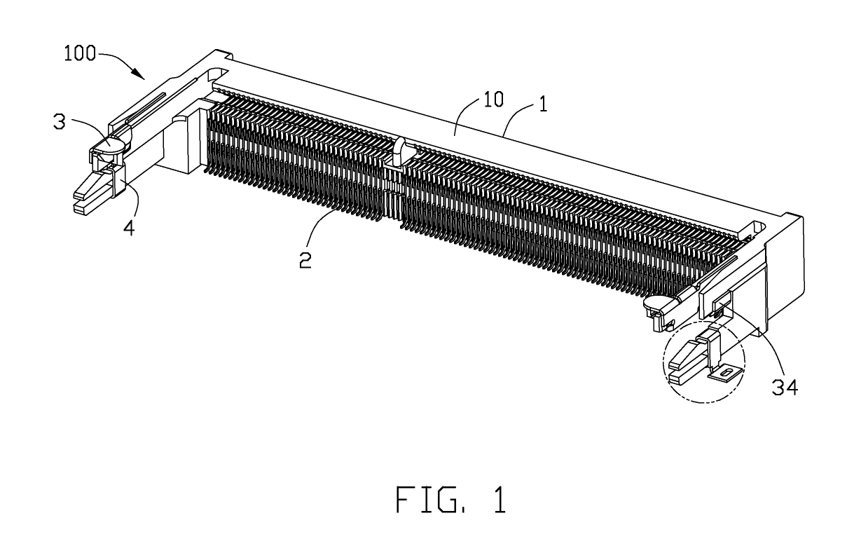

Referring to FIG. 1, a card edge connector 100, which is embodied as a SO-DIMM (Small Outline Dual In-line Memory Module) connector, which comprises an insulative housing 1, a plurality of terminals 2 set in the insulative housing 1, a pair of metal plates 3 and a pair of grounding pads 4.

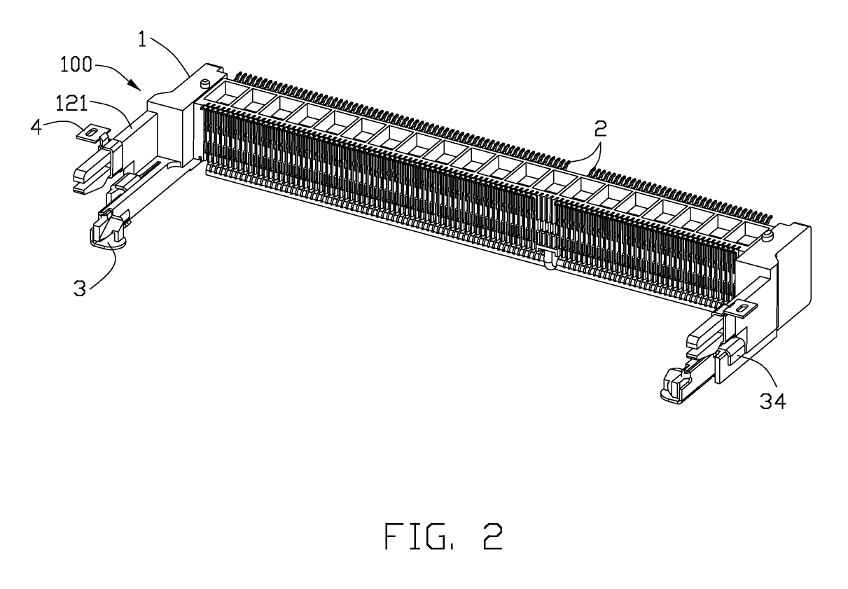

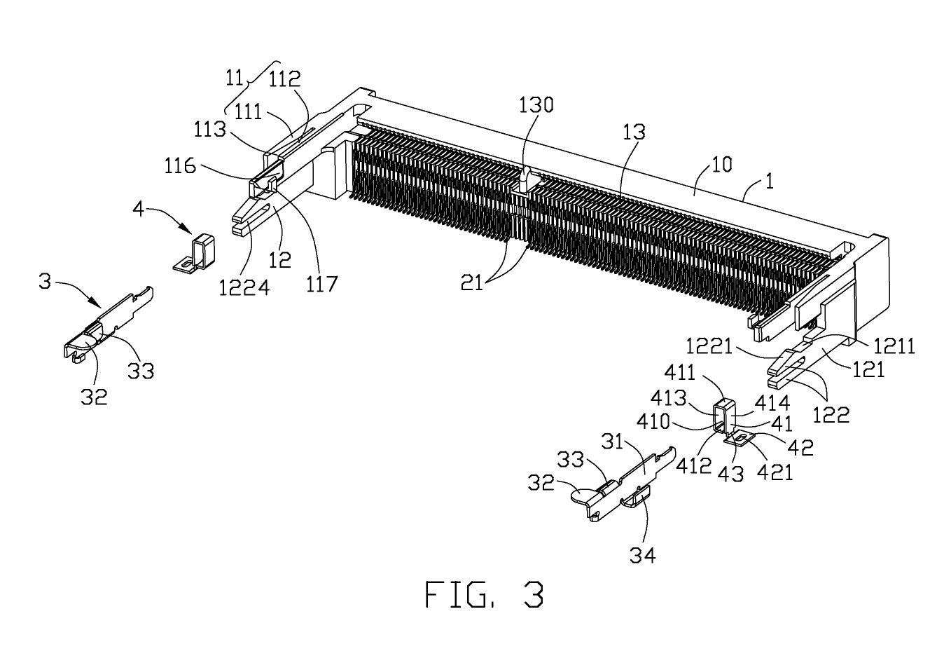

Referring to FIGS. 2 and 3, the insulative housing 1 includes a lengthwise base portion 10, a pair of retaining arms 11 extending from two opposite ends of the base portion 10 respectively and a pair of locating arms 12 located below the retaining arms 11 and extending from the two opposite ends of the base portion 10. The base portion 10 comprises a lengthwise card-receiving slot 13 for receiving a card (not shown) and a plurality of terminal-receiving passageways for receiving the terminals 2. A key 130 is set in the card-receiving slot 13 and divides the card-receiving slot 13 into two parts having different length so that it can prevent incorrect insertion of the card into the card-receiving slot 13. A receiving space for receiving the card is formed between the both retaining arms 11. Each of the metal plates 3 is disposed on the corresponding retaining arm 11 for helping the retaining arm 11 to guide and retain the card in a horizontal plane when the card is rotatably inserted into the card-receiving slot 13 such that it greatly improves the strength of the retaining arms 11. Each of the grounding pads 4 is assembled on the locating arm 12 under the corresponding retaining arm 11 for securing the card edge connector 100 onto the printed circuit board (not shown).

The card edge connector 100 defines a front-to-rear direction and a vertical direction perpendicular to the front-to-rear direction. Each of the retaining arms 11 comprises an inner arm 112 extending from the base portion 10 and an outer arm 111 located at the outside of the inner arm 112 extending from the base portion 10 and positioned beside the inner arm 112 for preventing the inner arm 112 from moving outwardly. The inner arm 112 and the outer arm 111 form a fork shaped configuration and a receiving aperture 113 is defined therebetween for holding the metal plate 3 therein to improve the strength of the retaining arms 11. A guiding portion 116 slopes to the receiving space with thereof the bottom for abutting against a top face of the inserted memory module, and a stop portion 117 extends into the receiving space from the bottom of the guiding portion 116 for preventing the inserted card releasing from the card edge connector 100 in the horizontal direction.

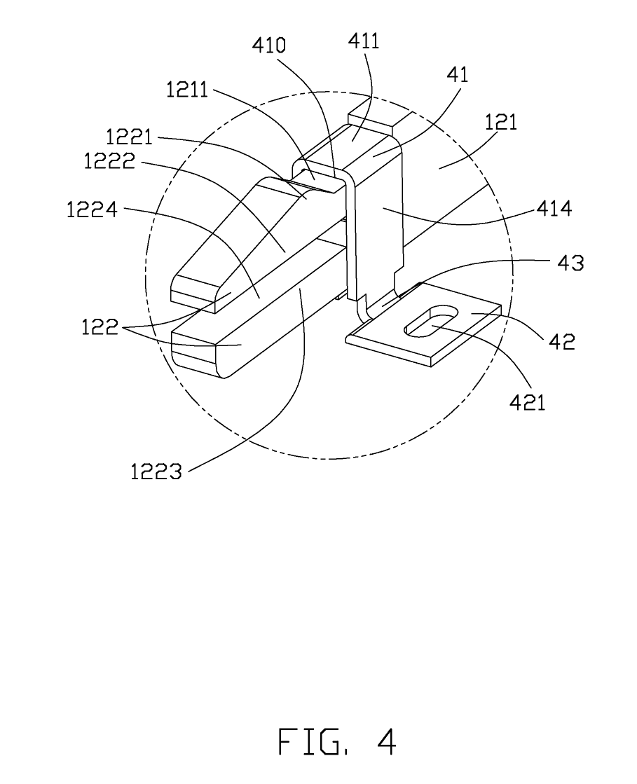

Further referring to FIG. 4, each of the locating arms 12 comprises a locking portion 122 having a spring locking bar 1222 and a horizontal bar 1223 located below the spring locking bar 1222 and an extending portion 121 connecting the base portion 10 to the locking portion 122. A slip or slot 1224 is formed between the spring locking bar 1222 and the horizontal bar 1223 and an interfering portion 1221 is formed at the top of the spring locking bar 1222. A notch or recess 1211 located adjacent to the interfering portion 1221 is formed at the top of the extending portion 121.

The metal plate 3 includes a body portion 31, a pressing piece 32, a guiding piece 33 and a hook portion 34. The body portion is received in the receiving aperture 113 and covers the outside surface of the inner arm 112. The pressing piece 32 bends inwardly from the top and front end of the body portion 31. The guiding piece 33 extends inwardly and has a downward opening cooperating with the guiding portion 116. The hook portion 34 extends outwardly from the bottom and the middle portion of the body portion 31 and has an upward opening receiving the bottom edge of the outer arm 111. The metal plate 3 holds the bottom of the inner arm 112 and the top of the outer arm 111, therefore, when a card is rotatably inserted into the card-receiving slot, the inner arm 112 is pushed outwardly and the hook portion 34 exerts a retaining force to the outer arm 111 in order to prevent the rupture of the inner arm 112.

The grounding pad 4 comprises a main body 41 located at the notch 1211, a horizontal solder pad 42 extending outwardly and perpendicular to the main body 41 and a connecting portion 43 connecting the main body 41 to the solder pad 42. The main body 41 includes a rectangular frame 410 having an upper wall 411 set in the notch 1211 and a bottom wall 412 which is in parallel with the upper wall 411, an inner surface 413 and an outer surface 414. The solder pad 42 defines a through hole 421. When the solder pad 42 is soldered onto the PCB, the through hole 421 can serve as a reservoir to receive additional solder mass so that the grounding pads 4 can be soldered onto the PCB more securely, and the connecting portion 43 can prevent the solder mass from wicking up to the locating arms 12 and contaminating the locating arms 12. The terminals 2 have tails 21 set in a same plane with the solder pad 42. When the grounding pad 4 is seated into the notch 1211, the grounding pad 4 can be moved in the notch 1211 along the up-to-down and card-insertion direction, so a commonly-known issue of cold joint can be prevented.

When the grounding pad 4 is assembled to the locking bar 122, firstly the rectangular frame 410 is located in the front end of the locking bar 122 and then the grounding pad 4 is pushed along the plug direction till the upper wall 411 is securely seated in the notch 1211. Because the spring locking bar 1222 has an interfering or guiding portion 1221, the grounding pad 4 can be easily and securely assembled at the locking bar 122. When the grounding pad 4 is dismounted from the locking bar 122, firstly the spring locking bar 1222 is depressed downwardly and then the floating bar 4 can be removed from the locking bar 122 easily. So it is easy to replace the grounding pad 4 when necessary via this kind of design. The cost of the assembly or disassembly can be decreased.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card edge connector for connecting a card to a printed circuit board comprising:
an insulative housing including a lengthwise base portion having a card-receiving slot and a pair of locating arms located at two sides of the card-receiving slot, each locating arm defining an extending portion extending forwardly from the base portion;
a plurality of contacts retained in the insulative housing and extending into the card-receiving slot to communicate with the card;
a pair of grounding pads each including a main body having a frame and a solder pad;
wherein each locating arm further includes a spring fork-shaped locking portion extending from the extending portion to have a contracted deformation for the frame of the grounding pad being assembled over to the extending portion and prevents the grounding pad releasing from the corresponding locating arm when the frame of the grounding pad was assembled to the extending portion.

2. The card edge connector as claimed in claim 1, wherein the locking portion includes a locking bar, a horizontal bar below the locking bar and a slip formed between the locking bar and the horizontal bar, and an interfering portion extends upward smoothly from the top of the locking bar.

3. The card edge connector as claimed in claim 2, wherein the frame is rectangular and has an upper wall and a bottom wall parallel with the upper wall, the solder pad is parallel with the upper wall.

4. The card edge connector as claimed in claim 3, wherein a connecting portion connects the main body to the solder pad, and the main body is located at a position higher than the solder pad.

5. The card edge connector as claimed in claim 3, wherein a through hole is formed at the solder pad, and the through hole is elliptical.

6. The card edge connector as claimed in claim 3, wherein a notch is formed at the extending portion adjacent to the interfering portion for receiving the upper wall of the frame of the grounding pad, and the interfering portion is higher than the extending portion.

7. The card edge connector as claimed in claim 6, wherein the notch and the slip have overlap parts viewed from a up-bottom direction.

8. A card edge connector for connecting a card to a printed circuit board comprising:
an insulative housing including a lengthwise base portion having a card-receiving slot and a pair of locating arms located at two sides of the card-receiving slot, each locating arm defining an extending portion extending forwardly from the base portion and a locking extending forwardly from the extending portion;
a plurality of contacts retained in the insulative housing and extending into the card-receiving slot to communicate with the card;
a pair of grounding pads assembled to the extending portions in a front-to-back direction, each grounding pad including a main body having a frame encircling the extending portion and a solder pad;
wherein the locking portion comprises a slit formed therein and extending along the front-to-back direction so as to enhance its flexibility for the frame passing over easily.

9. The card edge connector as claimed in claim 8, wherein the locking portion comprises a horizontal bar formed at lower side of the slit and a locking bar formed at upper side of the slit, the locking portion has a interfering portion protruding upwardly to resist the frame backwardly.

10. The card edge connector as claimed in claim 8, wherein a connecting portion connects the main body to the solder pad, and the main body is perpendicularly to the solder pad, and the bottom of the main body is higher than the top of the solder pad, a through hole is formed at the solder pad, and the through hole is elliptical.

11. The card edge connector as claimed in claim 8, wherein a notch is formed at the extending portion for receiving an upper wall of the frame of the grounding pad.

12. The card edge connector as claimed in claim 11, wherein the notch and the slip have overlap parts viewed from a up-bottom direction.

13. An electrical connector for receiving a memory module with a pair of notches on two opposite side edges under rotational insertion/withdrawal, comprising:
an elongated housing defining a receiving slot in a lengthwise direction;
a plurality of contacts disposed in the housing by two sides of the receiving slot;
a pair of retaining arms located at two opposite ends of the housing and extending forwardly in a front-to-back direction perpendicular to said lengthwise direction, each of said retaining arms being equipped with a guiding portion with thereof a bottom face for abutting against a top face of the memory module to prevent movement of the memory module in a vertical direction perpendicular to both said lengthwise direction and said front-to-back direction, and a stop portion for reception with the corresponding notch of the memory module for preventing movement of the memory module in the front-to-back direction; and
a pair of locating arms located at the opposite ends of the housing and extending in the front-to-back direction under the pair of retaining arms in the vertical direction, respectively, each of said locating arms being equipped with thereon a grounding pad floatable in the vertical direction relative to the housing for mounting to a printed circuit board on which the housing is seated; wherein
each of the retaining arms is pivotally deflectable in the lengthwise direction while each of the locating arms is pivotally deflectable in the vertical direction.

14. The electrical connector as claimed in claim 13, wherein floatation of the ground pad relative to the housing is derived from a gap between the grounding pad and the locating arm.

15. The electrical connector as claimed in claim 14, wherein the grounding pad is configured to define a thought opening in the front-to-back direction so as to be assembled to the corresponding locating arm in the front-to-back direction.

16. The electrical connector as claimed in claim 13, wherein each of the locating arms defines a recess to receive and position the corresponding grounding pad.

17. The electrical connector as claimed in claim 16, wherein each of the locating arms defines a guiding portion in front of the corresponding recess for guiding assembling of the grounding pad into the corresponding recess.

18. The electrical connector as claimed in claim 13, wherein each of the locating arms includes a lower stationary horizontal bar and an upper deflectable locking bar spaced from each other with a slot therebetween in the vertical direction.

19. The electrical connector as claimed in claim 13, wherein the locating arm and the corresponding retaining arm have a similar length in the front-to-back direction.

20. The electrical connector as claimed in claim 13, wherein in a cross-sectional view, the grounding pad surrounds the corresponding locating arm.
